(19) United States
(12) Patent Application Publication
(10) Pub. No.: US 2025/0005328 A1
(43) Pub. Date: Jan. 2, 2025

(54) SYSTEM AND METHOD FOR SPECIFICATION, CODIFICATION, AND DEPLOYMENT OF COMPOSITE ARTIFICIAL INTELLIGENCE SYSTEMS

(71) Applicant: Filuta AI Inc., Houston, TX (US)

(72) Inventors: Filip Dvorak, Houston, TX (US); Slavomir Svancar, Praha 9 (CZ); Gregory Michael Youngblood, Las Cruces, NM (US); Martin Dousek, Praha 3 (CZ); Michal Ficek, Prague (CZ); Tomas Balyo, Karlsruhe (DE)

(21) Appl. No.: 18/761,037

(22) Filed: Jul. 1, 2024

Related U.S. Application Data
(60) Provisional application No. 63/524,594, filed on Jun. 30, 2023.

(51) Int. Cl. G06N 3/045; G06N 3/08

(52) U.S. Cl. CPC G06N 3/045; G06N 3/08

(57) ABSTRACT

A system and method for deployment of composite artificial intelligence systems is provided. Models are obtained and each model is based on a technique of artificial intelligence and associated with a target function for which a goal is to be achieved. A composition is generated by combining two or more of the models. Control nodes marshal the input data into or the output data out of a set of models and configure those models and any associated computation services for those models. Simulation testing is performed by mapping the composition into a simulation representative of the target system. The composition is deployed to the target system. Information regarding actions to achieve the goal of the target system is obtained based on the deployed composition. The actions are executed by the target system to achieve the goal or to control systems to achieve the goal.

### FIELD

The present invention relates in general to artificial intelligence and, specifically, to a system and method for specification, codification, and deployment of composite artificial intelligence systems.

### BACKGROUND

The modeling of real world problems is important to address real world issues, make predictions, and identify solutions. Multiple techniques for modeling real world problems are known and used currently. Yet, none of the techniques have been identified as most efficient nor a dominating technique that is widely used.

Specifically, single models created for addressing real-world problems face challenges, such as being able to perform many disparate functions outside of the design or training for that specific model. The models cannot reason about the optimal plan of actions to achieve a goal, dispatch and monitor action execution, act on state information, diagnose failures, and adapt to unexpected events all in a single model. Further, current automation challenges exist, which involve connecting all actors in the system and collecting real-time operational data.

In addition to the single model approach, modeling real-world problems can also be seen as a composition of chained, concurrent (parallel or interleaved) and/or nested techniques and models, using a most efficient technique or model for each sub-problem of the real-world problem. Validation of this composition approach to solving industrial problems can be found in studies performed by Gartner 2022, where composite AI has emerged as a promising technique, following the underperformance of deep learning and machine learning in applied projects.

Therefore, a need remains for a system and method for providing a common ground for the composition of various models and techniques into a system. Preferably, the composition of many models is used to perform a distinct set of functions producing output from data input. Intelligent automation services act towards user-defined goals based on the model composition, along with observations of the world.

### SUMMARY

Currently, many techniques exist for modeling real-world problems; however, no single technique dominates as the most efficient. Thus, extremely efficient and wide use models are desired to solve different types of real-world problems. A composite AI system that integrates multiple models and techniques, such as AI planning, machine learning, scheduling, graph theory, constraint programming and large language models, can be used for solving problems across different domains, such as industrial automation and intelligent service creation. The composite AI system leverages a graph-based structure to manage relationships and dependencies to ensure tasks are executed in a correct order, while control nodes orchestrate data flow and model execution to enable the composition of various models into a unified operational schema.

The composite AI system includes online and offline data connectors for real-time processing and employs a comprehensive framework for model composition, computational services, and logic-driven control. The architecture supports deployment in containerized environments, providing flexibility, scalability, and efficient control for target systems.

One embodiment provides a system and method for deployment of composite artificial intelligence systems. Models are obtained and each model is based on a technique of artificial intelligence and associated with a target function for which a goal is to be achieved. A composition is generated by combining two or more of the models. Control nodes marshal the input data into or the output data out of a set of models and configure those models and any associated computation services for those models. Simulation testing is performed by mapping the composition into a simulation representative of the target system. The composition is deployed to the target system. Information regarding actions to achieve the goal of the target system is obtained based on the deployed composition. The actions are executed by the target system to achieve the goal or to control systems to achieve the goal.

Still other embodiments of the present invention will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a graph diagram showing, by way of example, a behavior tree for monitoring and adapting a plan in execution.

FIG. 2 is a graph diagram showing, by way of example, a composition framework.

FIG. 3 is a block diagram showing, by way of example, a control node architecture.

FIG. 4 is a graph diagram showing, by way of example, a directed acyclic graph of the composition framework of FIG. 2.

FIG. 5 is a graph diagram showing, by way of example, a behavior tree for the composition framework of FIG. 2.

FIG. 6 is a block diagram showing, by way of example, a composite AI system.

FIG. 7 is a screenshot showing, by way of example, an interface for language development.

FIG. 8 is a flow diagram showing, by way of example, a process for creating and editing a composition.

FIG. 9 is a flow diagram showing, by way of example, a process for running a composition.

FIG. 10 is a block diagram showing, by way of example, a high level target system architecture.

### DETAILED DESCRIPTION

Learning a single end-to-end model is rarely computationally feasible. Instead, end-to-end models are typically composed of multiple heterogeneous models, some of which are machine-learned while others are human-built using AI and operations research modeling techniques. Accordingly, a system and method for the design, development and deployment of composite AI systems helps support and encourage widespread use of the composite systems.

Key building blocks for constructing automation systems designed as a graph are provided, with the flexibility to transform into many graph forms for deployment. A data and model aware, logic-driven control node central to defining a composition that unifies a plurality of disparate models is introduced. The compositions can be used to generate code, be containerized, and then deployed autonomously.

The underlying structure of a composite AI composition definition is a graph, which is a mathematical structure used to model pairwise relationships between objects. A graph includes a set of vertices, called nodes or points, and a set of edges, known as links or lines, that connect pairs of vertices. The vertices or nodes are the fundamental units or points in a graph. Each vertex can represent an entity, such as a process step in a procedure. The edges or links can each represent a relationship, interaction, or pathway between the entities represented by the vertices.

Describing a system as a graph is beneficial for implementation because the graph offers a clear visualization and interpretation of relationships and interactions through nodes and edges. The visualization aids in understanding and communicating the system's structure with little ambiguity. Graph-based representations allow the user of efficient algorithms for tasks like searching, finding shortest paths, and optimizing resource allocation. Additionally, graphs support modular design, where components can be independent developed and reused, enhancing maintainability and scalability, as well as accommodate dynamic changes, making them ideal for evolving systems that adapt over time.

Further, graphs can effectively represent complex hierarchical and network structures, capturing interdependencies among various parts of the system. This approach aids in problem decomposition, which allows the system to be broken down into manageable subproblems. Various data structures, such as adjacency lists and matrices, efficiently store and manipulate graph data, ensuring scalability for large datasets. Graphs are also useful for simulation, modeling, and predictive analytics, providing valuable insights for planning and decision making. Overall, graphs used to describe systems can leverage their structured representation and the power of graph theory to make the system more efficient, flexible, and scalable. For many implementation instances, one types of graph can be used including Directed Acyclic Graphs (DAG) and Behavior Trees (BT).

A DAG is a special type of graph that has two main characteristics, being directed and acyclic. With respect to the directed characteristic, the edges in the graph have a direction, meaning they go from one vertex to another specific vertex, whereas for acyclic characteristic graphs, the graph has no cycles, which means there is no way to start at a vertex and follow a directed path that loops back to the same vertex. A DAG is useful for representing systems by effectively managing order and dependencies and ensuring tasks are executed only after their prerequisites are met. The cycle free structure eliminates circular dependencies and simplifies dependency resolution, while avoiding deadlocks. The DAG supports efficient algorithms for optimizing performance and resource utilization. DAGs ensure correct order and efficient execution, and are valuable in predictive modeling and simulations to provide clarity and simplify the representation of complex systems. Overall, DAGs offer a robust and efficient framework for system management and optimization.

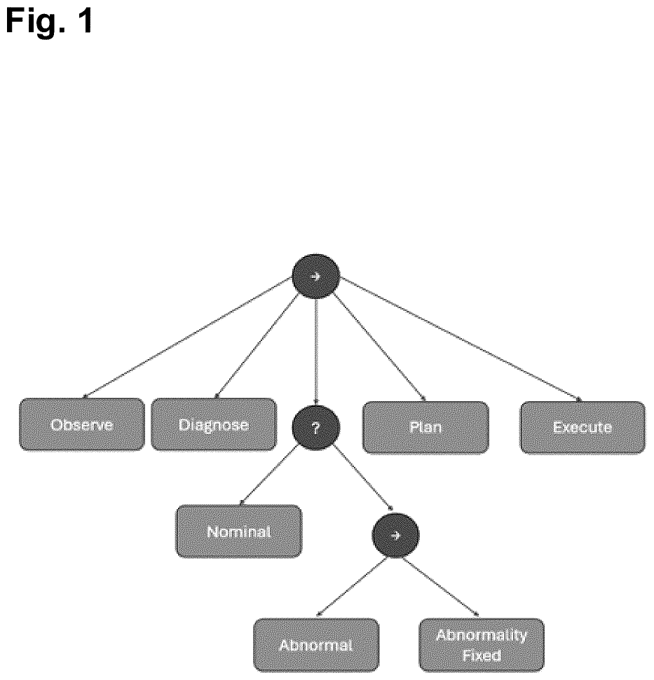

A BT is a hierarchical graph that defines the behavior of autonomous agents, particularly in video game Artificial Intelligence (AI), robotics, and complex system control. A BT includes nodes representing different tasks or actions, structured in a tree-like manner where the root node is the starting point. Each node in the tree can be a composite, decorator, or leaf node, where composite nodes control the flow of execution by organizing other nodes, such as sequences or selectors. Decorator nodes modify the behavior of their child nodes by adding conditions or loops, while leaf nodes perform actions or checks. BT allow for clear and modular representations of complex behaviors, making them easy to design, understand and maintain. BT also support flexibility and reusability as different behaviors can be combined and nested to form sophisticated decision making processes to allow agents to reach dynamically to changing environments and achieve goals efficiently. FIG. 1 is a graph diagram showing, by way of example, a behavior tree 10 for monitoring and adapting a plan in execution. A node, such as a top node 11 and a nested node 18, evaluates as: 1) a success if all its children 12-15 evaluate to success; 2) failure if at least one child node evaluates to failure; and 3) running if at least one node evaluates to running while none of the nodes evaluate to failure. A middle node 16 can evaluate to the following: 1) success if at least one child evaluates to success; 2) failure if all children evaluate to failure; and 3) running if at least one child evaluates to running and none evaluate to success.

A benefit of behavior trees is that an original problem can be hierarchically decomposed by plugging in a behavior tree focused on a subproblem into another tree focused on a higher-level problem without needing to know details of the subproblem. Behavior trees can also incorporate planning and diagnosis. For instance, automated diagnosis can act as another node in the tree, and behaviors such as “if there is a single minimal diagnosis and the diagnosis rules are owned by a single service, restart the service” can be encoded into the tree as well. When a planner produces a plan of actions from the current state, these actions form a behavior tree where each action is represented by a single node. The node's success, failure, or running evaluation directly reflects the success, failure, or current execution of the action it represents. For example, when diagnosis can fail, the whole behavior tree fails.

Within a framework a behavior tree can be seen as a deterministic policy that observes the world with each tick of the tree and can send actions, such as “plan.” Planning can be a subproblem implemented as a policy through a solver that takes state, actions, and a goal to develop a plan for execution.

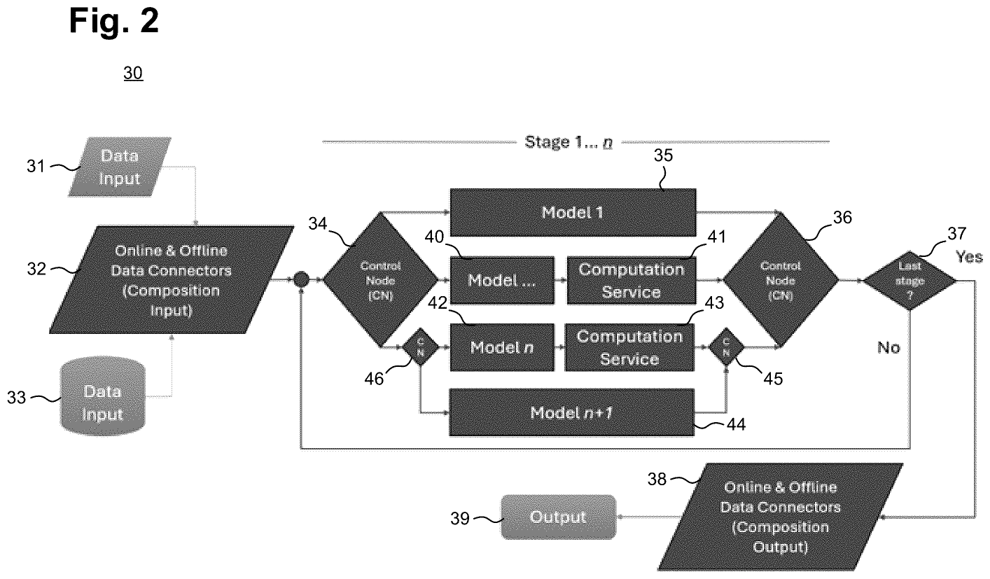

As described in detail below, the graphs can be used to organize components for a composite AI system. Specifically, the composite AI system can include an automated assembly of data connectors, domain and goal-based problem models, computational services, such as solvers, reasoners and large-language models, and appropriately configured control nodes using a graph-based organization into a service supported by an externally interfacing API that can be plugged into a target system for automation. A composition framework for the composite AI system includes components for making compositions. FIG. 2 is a graph diagram showing, by way of example, a composition framework 30. Online and/or offline data is input and adapted for distribution to one or more models organized into one or more stages. Novel control nodes 34, 36 can be flexibly configured to distribute data into and out of models 35, 40, 42, 44 in to, between, or out of stages. For instance, the output of control node 36 can feed into another stage of models defined by control node 34-1 with models 4x-1 and output control node 36-1, as well as other defined stages. If the data distribution has reached the last stage 37, online and offline data connectors 38 are utilized to provide composition output 39.

Some models 40, 42 require computational pipelining 41, 43 to execute. For example, a planning model needs to be run through a solver with a problem specification. A Generative Pre-trained Transformer (GPT) model needs to have its weights loaded into the configured transformer architecture and be run with a problem prompt. At the end of all stages, the composition produces output, which is a solution for the problem or task that is being solved. The composite core is wrapped in a service API and designed for deployment in a container or set of containers to provide the configured service both in testing and productions environments.

When building real-time intelligent services, both offline 33 and online data 31 can be processed. Offline data, which is typically used for model learning, can be large and is not significantly constrained by processing time. In contrast, online data is expected to arrive in real-time when the service is deployed and the results of processing the real-time data is also going to be produced and published by the service. Unlike conventional data connectors, the connectors 32 used here have extended functionality by adding preprocessing data transformations relevant to learning or deploying the models.

The models are generally the core workers in a composite AI system and can be pretrained with data and augmented with new data. The models can also learn from zero using the new data or be algorithmic in nature. When the models need to be augmented or developed from the ground up, model specific techniques can be applied, such as automated domain driven model synthesis, which is described in detail in U.S. Patent, Application, Ser. No. ______, titled “System and Method for Automated Data-Driven Domain Model Synthesis, filed on Jul. 1, 2024, which is hereby incorporated by reference in its entirety.

By applying various filters and transformations to a dataset ingested from a data connector, the composite AI system can define the state space or other features, which are used to learn the model. The same dataset can be used to define state spaces or inputs for multiple different modeling approaches. For example, a predictive task can be modeled as a dependency of the engine temperature on speed, road incline, and total weight, while simultaneously modeling vehicle logistics using classical planning.

Complex composite AI systems can be created by providing a control mechanism to combine, select, transform, deconstruct, and configure how the data flows into and out of the models in each stage until final output. Each control node is configured to marshal the data into or out of a set of models and configure the set of models as required using the following configuration elements: 1) permeability, which defines how data flows through the gate; 2) combination, which defines how inputs are combined before being passed to one or more models downstream; 3) selection, which defines how selected inputs are passed to one or more models downstream if at all; 4) transformation, which defines how inputs are altered before being passed to one or more models downstream; 5) downstream model configuration, which defines specific model configurations for each model as needed for input; and 6) orchestration, which defines conditions of received outputs and when or how to proceed in processing. Orchestration may only require a few responses instead of all responses from a set of upstream models before proceeding and may require specific properties to the responses before proceeding. With respect to downstream model configuration, each input into a model, for example, an LLM may specify some specific hyperparameters associated for processing the input. Also, there are different levels of permeability, including fully permeable, partially permeable, and impermeable. Fully permeable occurs when data is a complete pass-through to one or more models downstream and partially permeable occurs when data is a partial pass-through to one or more models downstream and can be combined, selected or transformed before being passed to the models. Finally, impermeable occurs when data is not passed through and will be combined, selected, or transformed before being passed to one or more models downstream, if at all.

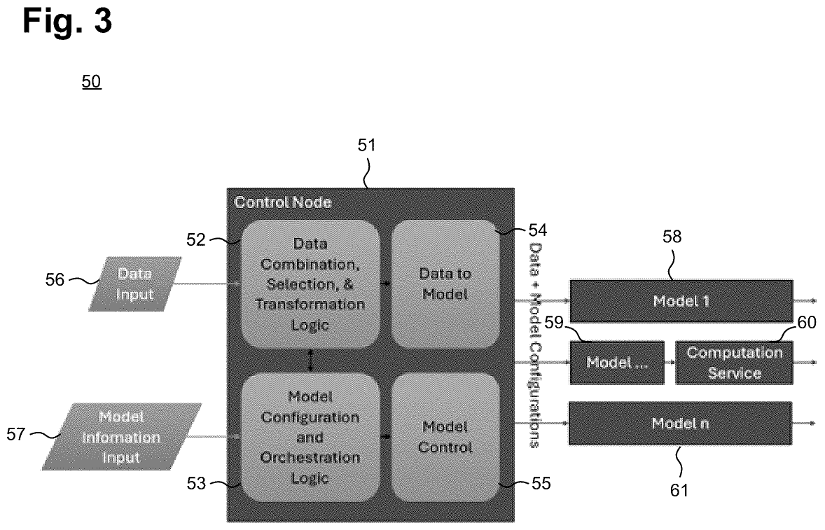

FIG. 3 is a block diagram showing, by way of example, a control node architecture 50. Data 56 comes into a data combination, selection, and transformation logic component 52 of a control node 51. The control node 51 also includes a model configuration and orchestration logic component 53, a data to model component 54, and a model control component 55. The data combination, selection, and transformation logic component 52 applies logic rules to the incoming data to combine, select and transform the data. A model configuration and orchestration logic component 53 receives information about the models available for use and is configured through logic rules on how to set up, execute and orchestrate downstream models. The data combination, selection and transformation logic component 52 and the model configuration and orchestration logic component can share information that informs logic rules for processing. The data to model component 54 provides the data to the appropriate downstream components, which may be the system output. The model control component 55 configures the downstream models and kicks off their operation as defined by the logic rules. The control nodes 51 always have incoming data and some outgoing data, but may not have any model input or control. Any logical specification system can be used to implement a control node, such as, but not limited to, programming languages, logic gate circuitry, biological neural networks, photonic circuits, qubits, fluidics, analog circuits, DNA strands, and spiking neural networks.

One example of how control nodes are used in a stage is to reduce LLM hallucinations, generated incorrect or fabricated information, by passing the same prompt into each of a set of LLM models, such as ChatGPT, Llama, and Gemini, in parallel. The outputs are then transformed into an intersecting set so that only outputs that are in fuzzy match are passed to the next stage. Information that is not the same in each response is filtered to reduce inconsistent aspects, which are often manifested as LLM hallucinations.

Control nodes can output to other control nodes and be nested in model flows. Control nodes fit neatly into the system graph as nodes before and after models and model processing nodes. Most times system control is best defined as a DAG or BT, but in some embodiments just a directed graph may be used with cycles. These cycles typically specify a loop between control nodes so that information may be processed multiple times by the same set of models.

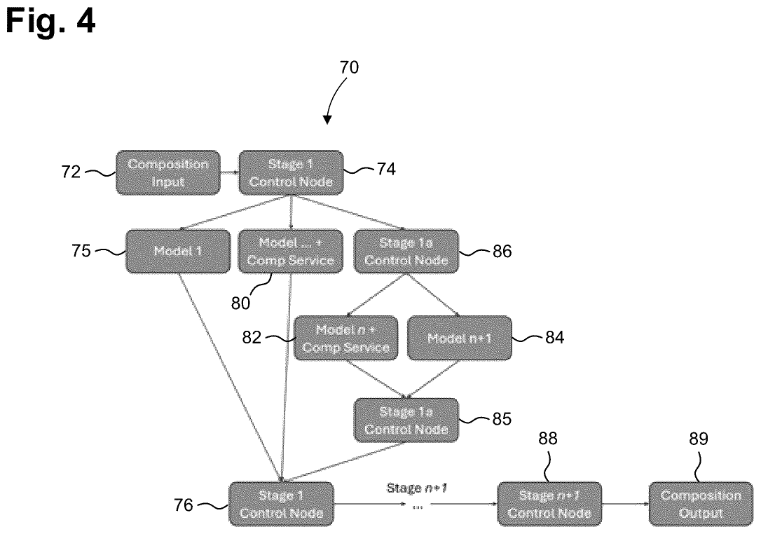

FIG. 4 is a graph diagram showing, by way of example, a directed acyclic graph 70 of the composition framework of FIG. 2. Data is input 72 and received by a stage 1 control node 74, which corresponds with the control node 34 of FIG. 2. The data 72 flows via the control node 74 to model 1 75, which corresponds with the model 1 35 of FIG. 2, to model . . . +computation service 80, which corresponds to model . . . 40 and computation service 41 of FIG. 2, and to stage 1a control node 86, which corresponds to control node 46 of FIG. 2. The data of model 1 75 and model . . . +comp computation service 80 flows to stage 1 control node 76, which corresponds to control node 36. Data from the stage 1a control node 86 flows to a model n+comp service 82, which corresponds to model n 42 and computation service 43 of FIG. 2, and to model n+1 84, which corresponds to model n+1 44 of FIG. 2. Output of the models, model n+comp service 82 and model n+1 84 flows to stage 1a control node 85, which corresponds to control node 45 of FIG. 2. Subsequently, the data output from the stage 1a control node 85 flows to stage 1 control node. The process can be repeated if there are additional stages 81 to go through. However, if the last stage is reached, composition output 89 is produced.

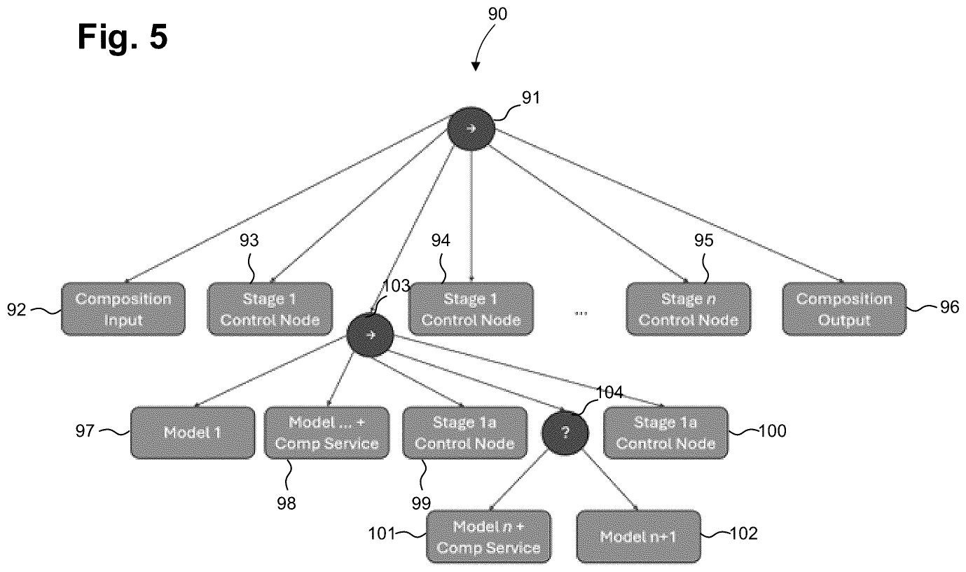

In a further embodiment, the composition framework can be displayed as a behavior tree. FIG. 5 is a graph diagram showing, by way of example, a behavior tree 90 for the composition framework of FIG. 2. Each node represented by a right facing arrow, such as the root node 91 and child node 103, is represented as a logical “AND” and has the properties of: 1) success if all its children evaluate to success; 2) failure if at least one node evaluates to failure; and 3) running if at least one node evaluates to running while no nodes evaluate to failure. Flowing downwards from the root node 91 are: 1) composition input 92, which corresponds to 32 of FIG. 2; 2) stage 1 control node 93, which corresponds to control node 34 of FIG. 2; 3) stage 1 control node 94, which corresponds to control node 36 of FIG. 2: 4) stage n control node 95, which corresponds to the next stage ending with the equivalent of control node 36-n, where n is the stage; and 5) composition output 96, which corresponds to output 39 in FIG. 2. A further node 103 also flows from the root node 91 and is associated with the following children: 1) model 1 97, which corresponds to model 1 35 of FIG. 2; 2) model - - - +comp service 98, which corresponds to model 40 and computation service 41 of FIG. 2; 3) stage 1a control node 99, which corresponds to control node 46 of FIG. 2; 4) Stage 1a control node 100, which corresponds to control node 45 of FIG. 2; and 5) a node identified with a question mark 104, which represents a logical “OR” and evaluates to: 1) success if at least one child evaluates to success; 2) failures if all children evaluate to failures; and 3) running if at least one child evaluates to running and no nodes evaluate to success. The node 104 has children, including model n+comp service 101 corresponding to 42 combined with 43 in FIG. 2 and model n+1 102 corresponding to 45 in FIG. 2.

Compositions can be designed to operate under various modalities. A common set is train and test, which includes learning and performing, exploring and exploiting. Control nodes can be specified with different logic configurations to support each desired mode of composition usage. In most embodiments, the mode is specified through a global attribute read by each control node as a function parameter, configuration file, environmental variable, command line argument, user input, class attribute, decorator pattern, or dependency injection. During control node specification, each modality logic is clearly defined.

### Architectural Solution Composition

Architectural Solution Composition involves building a graph, such as a behavior tree in this example, that combines multiple models with corresponding solvers, goals, and APIs into a service. Although the models share a single observation space, each model only considers its own local state space. Each model can be tied to computation service, such as a solver, which may continuously work on problem instances generated from the observations whenever triggered, such as by reaching the behavior tree associated with the model. For example, data flow through the graph initiates triggers, including performing work or evaluation when the data arrives. The system can use any type of software defined computation services, including planning solvers in the Unified Planning Framework and the wide range of AI techniques. The software defined computation services can also include transformers, classical planner, hierarchical planner, constraint satisfaction solvers, linear programming solvers, Boolean satisfiability solvers, satisfiability modulo theories solvers, and reinforcement learning.

Reasoning and action execution are encapsulated into the nodes of a behavior tree providing the grounds to define a composed automated reasoning, planning, and execution system in terms of tree composition. The tree composition is an operationalization of multiple models together with the corresponding solvers, actors, goals, and APIs into a service. Any two or more models in a composition are related either by:
1) nesting (hierarchical), when one model is fully nested within another, and the subsystem operating with the outer model can invoke the subsystem operating the inner model;
2) precedence or chaining (sequential), when a subsystem for the earlier model can be fully executed before running the subsystem for the later model; or
3) concurrent (interleaving and/or parallel), when subsystems for both models can run concurrently and interact with each other, for example by exchanging their best solutions.

These three model composition approaches are available to the solution architect through the control nodes and the architect can design a composition appropriate for the given real-world problem. While the system offers blueprint-compositions for different industries and use-cases within those industries, such as example solutions and templates, there are variations that fundamentally change the composition, such as having a customer who operates distribution centers both in cities and rural areas. The user may want to use a composition where a bin-packing problem precedes vehicle routing in the cities and vice versa in the rural areas, where the vehicles are rarely full.

The models share a single observation space, the control nodes picking only the data relevant for them, such as vehicle routing with time windows precedes running a planner in a food delivery system example. First, optimal assignments of orders to drivers are produced, which is equivalent to adding control knowledge to the more general planning problem, which is solved consequently. We consider each model to be tied with a computational service subsystem as appropriate, such as plan with a planner, problem with a solver which keeps solving the problem instances generated from the observations every time it is triggered.

The concept of model composition in the system is a tool given to the solution architect user. If desired, the user can build and compose models to guarantee optimal solutions. There can also be cases when optimality is infeasible or not desired, and the goal is to find solutions quickly with a reasonable distance from optimality, which are also supported.

### Service Code Generation

The service code is generated by filling out template code of various components of the composition or by configuring the pre-build services, such as by using JSON configuration files, environment variables, or API calls. A code or service template exists for every type of composition node. The solution is composed of a main orchestration service that has knowledge about all the components in the composition. The individual nodes are directly part of the orchestration service, in the case of simple nodes, or the orchestration service has lightweight proxy wrappers for a dedicated microservice that are logically part of the composition. The orchestration service communicates with the microservice using the proxy and can directly fetch and push data to it via the proxy or can use it to configure the wrapped service to specify data inputs and outputs. Individual nodes are decoupled, language independent, and are flexible to be part of a wide range of compositions. Programming language of the nodes ranges from C++, such as gaming code instrumentation and integration, through Python, including machine learning and symbolic AI solutions, to scripting language, such as external API calls. The list of programming languages is non-exhaustive as the composition is agnostic to the language used by a specific component. Automatic code generation also creates API specs and documentation for the unique set up described for the composition and exposes it via an API so the customer can easily incorporate it to their own tools that are not yet supported by the connectors.

All the parts of the solution templates, including the orchestration service and all prebuilt packages are packed into container technology by design. After code generation, all that is needed is to execute the already created build commands to create the containers and service manifest. These containers can be easily versioned, duplicated, and deployed locally or to a cloud solution. The containers can be used in various environments, such as testing, staging, demo, or production. Containerization allows exact specification of an environment where a service will run and serves as prevention from issues related to hardware or operating system differences. Depending on the composition complexity and requirements, the containerized services are deployed as a Docker Compose or Kubernetes deployment. Both Docker Compose and Kubernetes tools allow for direct interpretation of a composition in a versionable, replicable, re-deployable, and easily maintainable manifest file. This approach also supports making incremental, non-destructive changes to a composition, meaning if a user changes the composition in some way, only the parts that change will be redeployed and the rest will stay the same. Kubernetes deployment also allows scalability that automatically replicates a service if it is reaching resource limits or destroy replicas if they are underutilized to save computational costs.

### Deployment

Deploying services produced by the system is a push-button action for the user, which involves a cloud agnostic or computational platform deployment of containerized microservices at the backend. Once deployed, users can monitor the deployment status and interact with it at the defined network address through the API defined in the composition.

Final deployment also includes implicit and explicit tools and services not directly part of the data pipeline. These services allow incorporation of functional and non-functional requirements to the solution, such as High Availability, extensive monitoring and logging capacities, authorization, and authentication mechanisms. Tools, such as monitoring tools, are implicitly part of every deployment. An example of explicit supporting tools is the High Availability Service that will deploy the composition multiple times in multiple regions to serve as a failback if one instance fails, to allow faster and more scalable usage for customers from different regions, or for many customers in one place. The deployed services can be used as dedicated or distributed. Dedicated services are for a composition to which they belong, whereas distributed services are applied across multiple service environments, customer solutions, or even multiple customers.

In further detail, dedicated services can be models dependent on the environment where they are used or if the customer wants dedicated services running. Distributed services can be shared data sources that are the same for all customers, for example, a weather service or resource-heavy service that is cost prohibitive to use for a single deployment, such as an LLM service. Customer isolation is guaranteed by the solution by using dedicated services or by not sharing context in the distributed services.

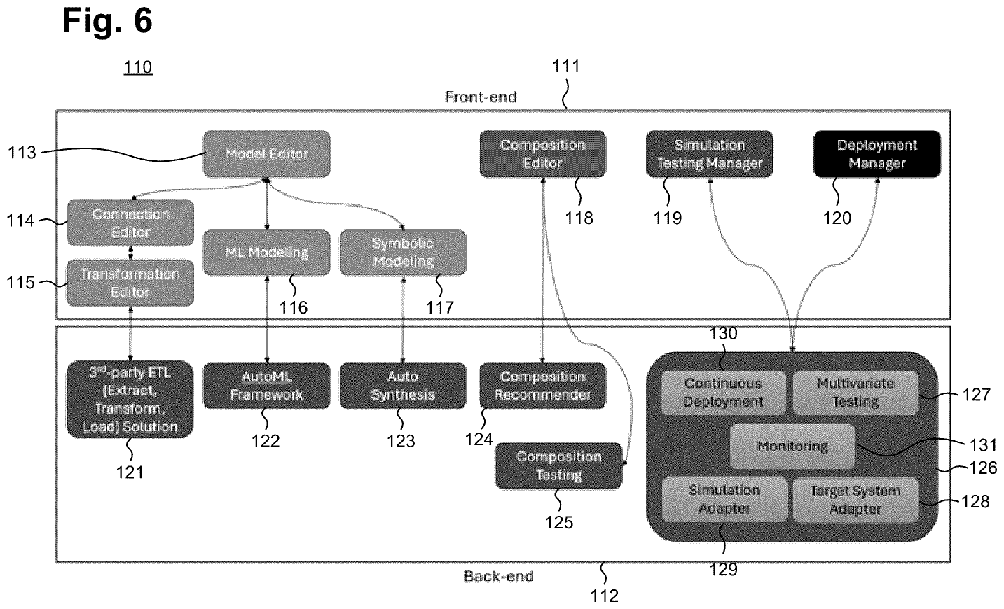

Composition is a core part of a complete system. FIG. 6 is a block diagram showing, by way of example, a composite AI system 110. A front end 111 of the system 110 includes a model editor 113, a composition editor 118, a simulation testing manager 119, and a deployment manager 120. The model editor 113 allows an expert user to define data inputs and how the inputs are transformed into an ingestible format, such as tabular data for predictors or machine learning models 116, or time series for symbolic models 117. Connector editors 114 or transformer editors 115 are then plugged into a machine learning or symbolic modeling approach. The expert user interactively adjusts and augments the proposed model until satisfied with the quality. The satisfaction may be based on accuracy for machine learning or a human check and test validation against input data for symbolic models. Models can be used in compositions and can have properties, such as defined input specifications, defined output specifications, defined model configuration parameters, defined model controls, defined computation and memory requirements, and characterization of performance on data.

The composition editor 118 takes multiple models and offers diverse options to combine them using control nodes to implement a graph that can be executed as a DAG, BT, or other forms. Combination of the models can be performed by identifying and combining the best fitting models for each part or subproblem of the input problem or task to be performed. Further, model efficiency can be based on speed, CPU, memory, precision, and recall. Also, data connectors can be used to provide shared observation space. The composition editor 118 encodes both the decomposition of the mathematical structure representing the real-world problem and the operationalization of the model with the behavior of a general agent. This feature allows for quick iteration, learning, and versioning of agents that provide intelligent automation services. The editor also specifies input and output of the composition.

The building blocks of a composition are explicitly versioned to support breaking changes. For example, if one service changes their API and another dependent service needs to adjust, the system can keep one composition that has services that have not adjusted on an old version and another composition that has the changes incorporated into a newer version. This supports failing back to older versions if needed, rolling out features gradually, and other cases where explicit versioning supports better system management. The building blocks can be different AI techniques, including a planner, solver, LLM, or classifier. Generally, the building blocks can include any type of symbolic or sub-symbolic AI component.

The building blocks are used in embodiments to: 1) construct the behavior tree or other executable graph in Python or another OOP language based on customer needs, such as C++ for game testing integrations, and 2) list the deployment requirement of the components necessary to run the composition. The BT represented by the composition in an embodiment has shown to be a low latency (1-5 ms), minimal-computation tree structure that constantly runs when deployed and manages the other components or containers considered to be serviced in this interaction.

The simulation testing manager 119 deploys compositions by mapping them into a simulation representative of the target system. Control of the simulation can run the composition through testing phases with the simulated system under any type of definable conditions. Simulations are optional and can test if the system works to precisely mimic the deployment environment to ensure there are no issues before connecting to a real world system. Outcomes of the simulation can include successful, which means the composition can be applied to the real world system or unsuccessful, which can trigger further processing and revision of the composition.

The deployment manager 120 deploys compositions by mapping them 1: n into running instances n, each with its own configuration and connected to a target system. For example, a location, such as a DNS name or IP number, and an authentication token are assigned as minimal configurations. The deployment manager continually monitors, terminates, and provides other features expected from cloud-deployed services with minimal downtime.

Compositions cannot tell the difference between the simulated and target systems when operating. Target system operators that also own reasonable fidelity simulators can plug their simulator in for testing or a generic simulator configured to simulate/emulate the target system can be used. Simulation is not required as some complex deployment systems do not have associated simulators, but if available should be used as part of a mature testing process prior to real system deployment.

Support back-end infrastructure components support the front-end configuration systems. Model editing is supported by existing libraries for data extraction, transformation, and loading 121; machine learning (ML) is supported by an AutoML Frameworks 122 that makes it easier to create ML solutions through automating/assisting the process of selecting, training, and tuning machine learning models, making it easier and faster to build effective predictive models without extensive manual intervention; and symbolic reasoning is supported by an Auto Synthesis 123 process described in detail in U.S. Patent, Application, Ser. No. ______, titled “System and Method for Automated Data-Driven Domain Model Synthesis, filed on Jul. 1, 2024, which is hereby incorporated by reference in its entirety. Composition editing is supported by a recommendation system 124 that suggests local compositional structures based on learned prior examples and testing 125 that support running data through the composition, providing inspection details for each component, and providing visibility across the composition components and connections to support testing and evaluation prior to testing in a simulated or actual environment. This is an important part of being able to debug a composite AI system. Simulation Testing and Deployment management are supported by a complex system 130 that provides Deployment and Continuous Deployment 130 (updates from changes) to run the Composite AI system in a simulated (through an adapter 129) or real environment (through an adapter 128), monitor 131 all instrumented and inspectable operations, and perform multivariate testing 127 by adjusting the available parameters of the system.

### Iteration and Inspection

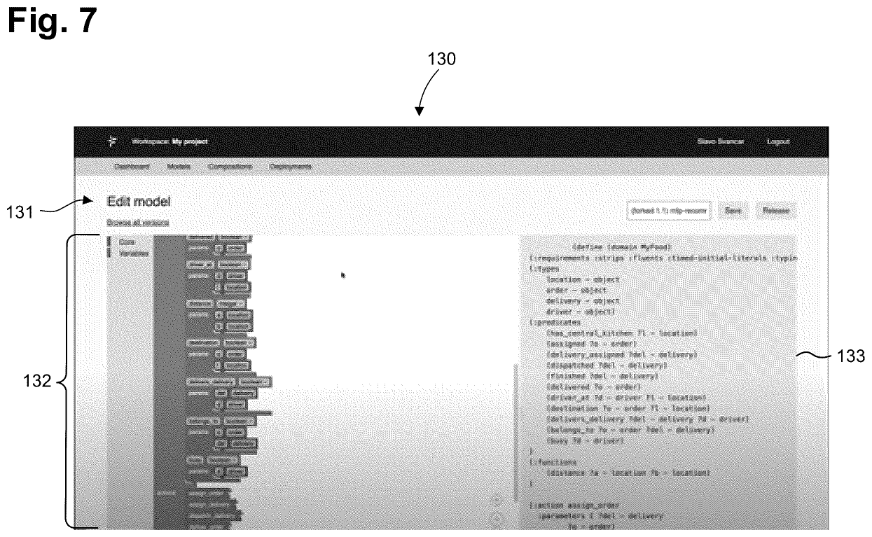

Users can access an interactive development interface. FIG. 7 is a screenshot showing, by way of example, an interface 130 for composition development. The interface 130 can support language development in parallel with a visual programming interface for creating a composition. The interface can also support Planning Domain Definition Language (PDDL) for editing planning models and a custom composition language used to describe a behavior tree graph with the Visual Programming Interface provided by Google Blockly. Iterative refinement through local testing and target deployment is supported by an inspection tool into each graph node and their edges. A left side of the interface 130 can show a title 131 for editing a graphical programming language version of the model 132. A language version, for example PDDL, of the model 133 can be provided on a right side of the interface 130.

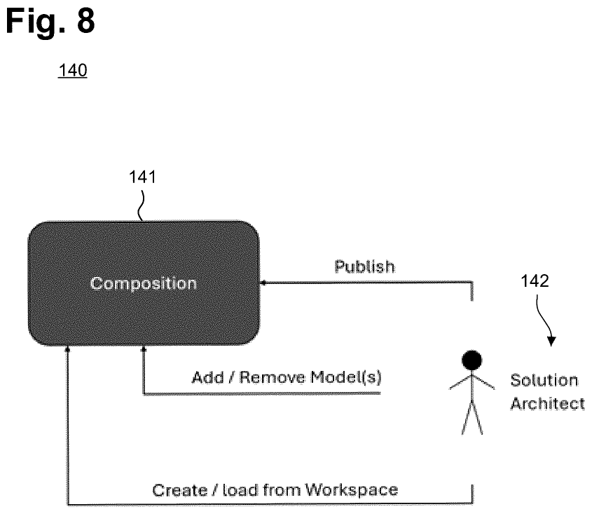

A solution architect can assemble one or more models into a composition. FIG. 8 is a flow diagram showing, by way of example, a process 140 for creating and editing a composition. Static data and/or streaming data are input through a configuration of data connectors. A solution architect 142 can create a composition 141 by combining different models through chaining (sequential), concurrent (parallel or interleaved), and/or nested (hierarchical) connections through a control node. Once a model is placed in a composition, additional computational services, such as a solver configuration, can be provided depending on the model type. The additional computational services can be provided when the performance of the solver for a given model is not sufficient by observing the type of component and whether or not it needs additional computational support. Planning models can go into a planner, language prompts and information can go into an LLM, and a problem can go into a solver. The composition can be edited via an interactive visual editor, where it can be saved and revisited. During editing, the solution architect can identify one or more models for adding to the composition or removing from the composition. Once the composition is complete, it can be published to prepare for compilation and deployment as an automation service.

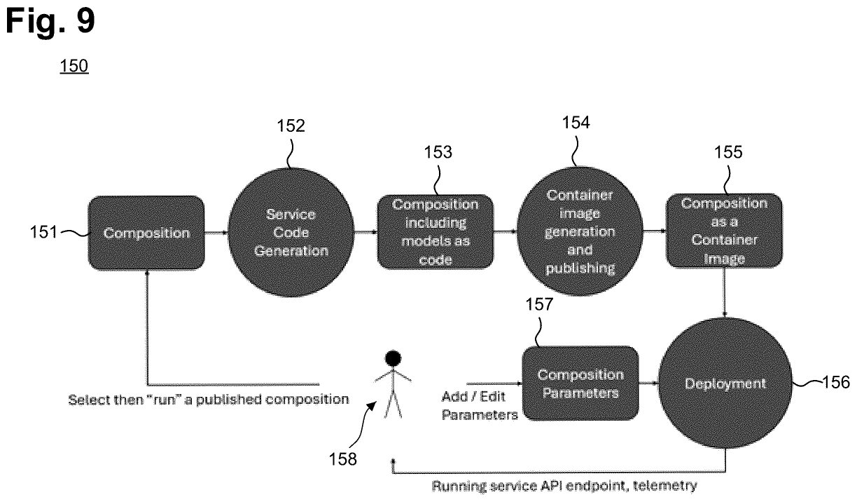

Once generated, the composition can be deployed. FIG. 9 is a flow diagram showing, by way of example, a process 150 for running a composition. A configured model composition can be transformed into a service, deployed, and run. Specifically, service code 152 from a configured composition 151 of models can be generated, along with telemetry instrumentation, such as distributed tracing, and API code and specification based on the contained models to output the composition with models as code 153. The composition is compiled into a set of container images 155 using Docker or Kubernetes for image generation 154. A deployment definition, including any optionally provided parameters is generated. The resulting artifacts, OS and file system snapshots with metadata 157 defining applications and their dependencies, to the platform's compute infrastructure for user workloads is automatically deployed 156. The user is updated about the state of the deployed service(s) defined by the composition along with service endpoint location and API specification. Each service implements one or more parts of a composition and are connected through a communication mechanism (e.g., message passing). The deployment can operate in control of a target system or a simulated system for exhaustive testing.

### Target System Application

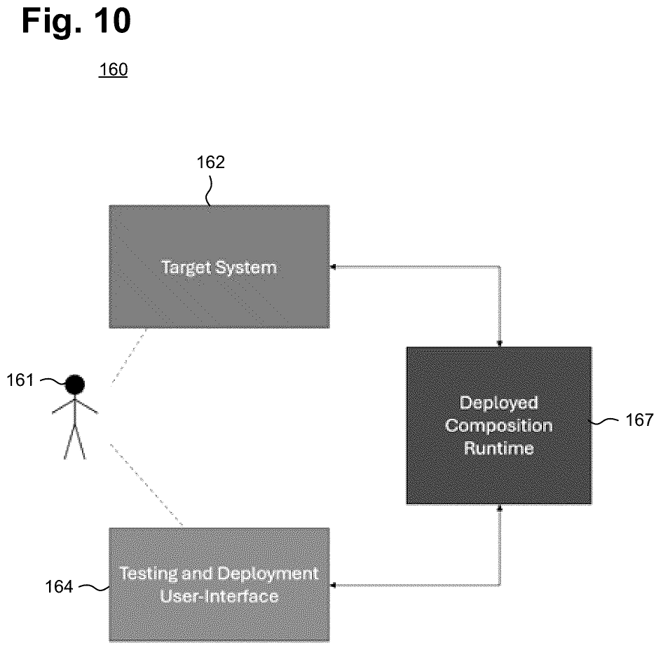

An approach for building a general hierarchical autonomous control architecture using a composition is provided. Specifically, the approach combined well-known techniques from satisfiability theory, automated planning, automated diagnosis, constraint programming, reinforcement learning, and behavior trees. FIG. 10 is a block diagram showing, by way of example, a high level target system architecture 160. A user 161 provides a target system 162 that accepts actions and provides a perception of it and its world's state. The user works with the backend system, which includes a deployed composition runtime 167, via a user interface 164 for testing and deployment. The user can configure one or more domain models and a composite system of AI-based components organized by a graph, such as a behavior tree, running through tests and deployment to solve problems through action-space control via a user interface, which accessible through an internetwork, such as the Internet or a cellular network.

As a running example, components set up for solving the Towers of Hanoi game as the target system is described. The Towers of Hanoi is a puzzle game that involves moving discs from one place or rod, to another. In one example, there are n rods, where n is typically three, and a stack of different sized discs. The goal of the puzzle is to move all the discs from one rod to another, following a few rules. The rules include only moving one disc at a time and never putting a bigger disc on top of a smaller disc. Also, the other rods can be used to help move the discs around, but each disc can only be placed on top of another disc or on an empty rod.

In the deployed composition, the symbolically trained Towers of Hanoi Model captures the model in PDDL and includes definitions of the target systems' predicates, actions, and goals. The model is paired with a planner in a layer book-ended with pass-through control nodes. A predicate is a function of a set of parameters that returns a Boolean as an answer. The model can be learned by taking raw logs from a system, an expert's domain knowledge, existing domain knowledge, such as existing PDDL descriptions, and other sources that provide domain knowledge through capture collecting into a knowledge base.

Knowledge capture primarily involves preparing a set of predicates that describe the domain under interest following any method of knowledge capture from a consultant or domain expert. The knowledge base may also include a description of predicates and their meaning extracted from the target system's raw logs. Predicates apply to a specific type of object or to all objects. Predicates are either true or false at any point in a plan and when not declared, they are assumed to be false. In the Towers of Hanoi example, the knowledge base can include information, such as the definition of useful predicates: “disc_on_disc(disc1, disc2)” means disc1 is on disc2, “smaller(disc1, disc2)” means disc1 is smaller than disc2, “disc_clear(disc1)” means disc1 is on the top and nothing lies on it. It may also define the goal to be achieved, such as “all discs lie on the last rod,” composed of predicates that are all true, such as disc_on_rod(disc1, rod3), disc_on_rod(disc2, rod3), and disc_on_rod(disc3, rod3). The initial state of the problem can also be defined using predicates that describe the input scenario and all combinations of disc and their size and location.

Information from the target system flows into and out of the deployed composition through the data connectors. This takes perception data from the external world state of the system or other systems that may accurately report data from the environment of the target system. The perception data can include any external information relevant to the domain of interest, such as weather, traffic conditions, and general knowledge from the outer world. The target system can provide telemetry operational logs, such as a raw stream/batch of data collected from system components. Returning to the Towers of Hanoi example, the operational logs can include keys pressed in the game by a human player. The composition output data connector transmits action information to the system. The action information can include transformed planned actions that lead to actual system change. In the example, the planned action can include “MoveDiscFromRodToRod,” which once translated to the target system can mean “press arrow up, press arrow left, press arrow left, press arrow left, press arrow down” as a sequence of virtual keyboard key presses.

A data connector takes in data in some form, digests the data from the source, such as a document, Google Drive, SFTPL, stream, websocket, Parquet, or Amazon S3, and passes the data in a defined structured data format to be processed by other entities. In the puzzle example, Keboola or some other data platform can be used to interchange data from the user's game (websocket, batches in some storage) into a format defined by the predicate store. This configuration can include format specifications, connectors, logins, or secrets. A data connector takes in predicate definition raw data, and transforms it given the predicate definition creating predicates from the input log stream. For example, for the Towers of Hanoi puzzle, “Rod1+ [disc3, disc2]” is converted to “disc_on_rod (disc3, rod1), disc_on_rod (disc2, rod1), disc_on_disc(disc2, disc3), smaller (disc2, disc3), disc_clear (disc2).

Within the deployed composition, the data connector passed input into a control node, which configures the trained Towers of Hanoi model with a computational service planner and passes in the input without editing. The model nodes execute and provide action output. A receiving control node accepts the output and without editing passes it on to the output data connector. Because the model was designed to take in raw system data and output, and provide appropriate action output, no transformations were necessary by the control nodes, but the capability is available.

Within the deployed composition, the data connector passed input into a control node, which configures the trained Towers of Hanoi model with a computational service planner and passes in the input without editing.

A data connector takes information from the composition output and converts it to an action description with parameters, which describes actions to be executed in the target system to achieve the desired goal. In the running example, “move (d1, d2, d3)” means to move disc 1 from disc2 to disc3. The output data connector interfaces with the target platform to execute all action commands on that platform, thus affecting the state through action.

The testing and deployment user interface is the front-end interactive tool that works with the user. The interface includes four main parts, which are described above in detail with respect to FIG. 6. Model development, by the model editor, uses a text-based language augmented by a visual programming language. In one embodiment, the modeling language is PDDL text and Blockly provides a visual builder. The user can iteratively refine the model through testing and deployment in a digital simulation of the target system and/or the target system itself. Model debugging tools provide insight and feedback for iterative refinement.

The models can be completely synthesized from raw observational data using a method, such as automated domain-driven model synthesis, as described in U.S. Patent, Application, Ser. No. ______, titled “System and Method for Automated Data-Driven Domain Model Synthesis, filed on Jul. 1, 2024, which is hereby incorporated by reference in its entirety. The interface tools can then be used to manipulate, edit, add, and remove actions within the synthesized model. The goal is to obtain a model having information from domain synthesis on which action to use or not to use for control with the target system. User augmentation can be used to refine the model and improve understandability by renaming predicates, goals, and actions, as needed.

Composition development is also included in the front end and uses a text-based language augmented by a visual programming language. In one embodiment, the composition language is text describing a behavior tree and Blockly provides a visual builder. A behavior tree visualizer also provides additional insights. The user can iteratively refine the composition and models through testing and deployment in a digital simulation of the target system. Composition debugging tools provide insight and feedback for iterative refinement.

The goal given one or more models, data connectors and control nodes, is to structure the composition workflow in a way that all components cooperate and achieve the desired system performance. In the Towers of Hanoi example, the composition invokes interfacing with the game to obtain the puzzle's state, such as which discs are on which rod, and deploys a planner to use the PDDL model to determine the action commands in a sequence that solves the provided puzzle. The composition then executes the commands on the target game. Subsequently, simulation testing provides pre-deployment feedback on the composition and underlying models in action.

Finally, deployment provides the ability to push control by the composition and models to the target system. Deployment includes live performance monitoring of the system in action and supports defining and observing performance through evaluation metrics. The deployment can target any type of cloud and container-based system.

As part of deployment, deployed model runtime takes the deployment setup, description of container images, image registry, relevant services, external endpoints, API's, data locations, and the input stream of target system predicates to deploy the model on a cloud-based platform. Deployed model runtime can run on any compute platform and can run services to allow communication according to description given by composition and ingest input data, such as preprocessed predicates, and output data, such as actions that lead to the goal. The system output is a stream of actions to be executed on the target system and the target system can make the actions happen in the real world given action input. In the puzzle example, the system could be a low-level Azure cloud deployment configurations of individual composition components, such as a planner, data store or serving APIs, networking and interoperability settings, VPNs, container registry settings and endpoints definition, needed to startup and execute a composed AI system to play the Towers of Hanoi.

While the invention has been particularly shown and described as referenced to the embodiments thereof, those skilled in the art will understand that the foregoing and other changes in form and detail may be made therein without departing from the spirit and scope of the invention.

What is claimed is:

1. A method for deployment of composite artificial intelligence systems, comprising:
obtaining models each based on a technique of artificial intelligence and associated with a target function for which a goal is to be achieved;
generating a composition by combining two or more of the models, comprising:
assembling components via a graph; and
running input data through the assembly of components, wherein one of the components comprises two or more of the models; and
obtaining output data based on the running of input data through the composition components;
employing control nodes to marshal the input data into or the output data out of the models and configuring the models and any associated computation services for the models;
performing simulation testing by mapping the composition into a simulation representative of the target system;
deploying the composition to the target system; and
obtaining information regarding actions to achieve the goal of the target system based on the deployed composition, wherein the actions are executed by the target system to achieve the goal or to control systems to achieve the goal.

2. A method according to claim 1, wherein the graph comprises one of a directed acyclic graph, directed graph, or behavior tree.

3. A method according to claim 1, further comprising:
revising the models prior to inclusion in the composition.

4. A method according to claim 1, wherein the models are combined via chaining, parallel or interleaved configurations, or nested configurations.

5. A method according to claim 1, further comprising:
receiving edits to the composition prior to deployment; and
revising the composition based on the received edits.

6. A method according to claim 5, further comprising:
2 running debugging tools on the composition to provide feedback for the revisions.

7. A method according to claim 1, further comprising:
running information from the target system in and out of the deployed composition via data connectors.

8. A method according to claim 1, further comprising:
transforming the information regarding the actions based on language specific to the target system.

9. A method according to claim 1, wherein the deployment is performed, comprising:
generate service code for the composition;
compile the composition into a set of container images; and
generate a deployment definition for deploying.

10. A method according to claim 1, wherein the composition is displayed via a user interface.

11. A method according to claim 1, wherein the goal to be achieved comprises one of a problem is to be solved, a system controlled, or data produced or transformed.

12. A system for deployment of composite artificial intelligence systems, comprising:
a database to store models each based on a technique of artificial intelligence and associated with a target function for which a goal is to be achieved;
a server comprising a central processing unit, memory, an input port to receive the models, and an output port, wherein the central processing unit is configured to execute the program code to perform steps to:
generate a composition by combining two or more of the models, comprising:
assemble components via a graph; and
run input data through the assembly of components, wherein one of the components comprises two or more of the models; and
obtain output data based on the running of input data through the composition components;
employ control nodes to marshal the input data into or the output data out of the models and configuring the models and any associated computation services for the models;
perform simulation testing by mapping the composition into a simulation representative of the target system;
deploy the composition to the target system; and
obtain information regarding actions to achieve the goal of the target system based on the deployed composition, wherein the actions are executed by the target system to achieve the goal or to control systems to achieve the goal.

13. A system according to claim 1, wherein the graph comprises one of a directed acyclic graph, directed graph, or behavior tree.

14. A system according to claim 1, wherein the models are combined via chaining, parallel or interleaved configurations, or nested configurations.

15. A system according to claim 1, wherein the central processing unit receives edits to the composition prior to deployment and revises the composition based on the received edits.

16. A system according to claim 5, wherein the central processing unit runs debugging tools on the composition to provide feedback for the revisions.

17. A system according to claim 1, wherein the central processing unit runs information from the target system in and out of the deployed composition via data connectors.

18. A system according to claim 1, wherein the central processing unit transforms the information regarding the actions based on language specific to the target system.

19. A system according to claim 1, wherein the central processing unit performs the deployment by generating a service code for the composition, compiling the composition into a set of container images, and generating a deployment definition for deploying.

20. A system according to claim 1, wherein the composition is displayed via a user interface.
